(19) United States
(12) Patent Application Publication
(10) Pub. No.: US 2008/0244005 A1
(43) Pub. Date: Oct. 2, 2008

(54) ENHANCED USER INFORMATION FOR MESSAGING APPLICATIONS

(76) Inventors: Uttam Sengupta, Portland, OR (US); Tanzeem Choudhury, Seattle, WA (US); Eric Garcia, Seattle, WA (US)

Correspondence Address: KACVINSKY LLC;C/O INTELLEVATE, P.O. BOX 52050, MINNEAPOLIS, MN, 55402, US

(21) Appl. No.: 11/693,867

(22) Filed: Mar. 30, 2007

(51) Int. Cl. G06F 15/16; G08B 5/22

(52) U.S. Cl. 709/204; 340/825.49

(57) ABSTRACT

Techniques involving messaging applications are disclosed. For example, an apparatus may include a presence determination module and a publication module. The presence determination module may infer one or more presence indicators regarding a user. These inference(s) may be based on sensor data. In addition, these inference(s) may be based on position information, and device activity data. The publication module publishes the one or more presence indicators to a messaging server. These presence indicator(s) may indicate an activity and/or a location context of the user.

### BACKGROUND

Instant Messaging (IM) has become popular method of communication among a wide range of user segments. One reason for this popularity is IM's ability to fit nicely between phone calls and e-mail. More particularly, IM communications are not as intrusive as phone calls and are not as asynchronous as e-mail. Users may employ IM applications to “chat”. In addition, IM applications may provide user presence information to other users known as “buddies.”

Such presence information may indicate to a user's buddies whether the user is online or offline. In addition, some applications have been able to provide presence information from calendar or scheduling applications. For instance, presence information may indicate from a user's schedule whether the person is unavailable (e.g., “in-meeting”, “out-of-office”, or “away among others”). However, such information only provides a shallow understanding of the user's state.

### BRIEF DESCRIPTION OF THE DRAWINGS

FIG. 1 illustrates an embodiment of an apparatus.

FIG. 2 illustrates an embodiment of a logic flow.

FIG. 3 illustrates an exemplary operational environment.

FIG. 4 illustrates an exemplary user interface.

### DETAILED DESCRIPTION

Various embodiments may be generally directed to techniques for providing user presence information to messaging applications. For instance, an apparatus may include a presence determination module and a publication module. The presence determination module may infer one or more presence indicators regarding a user. These inference(s) may be based on sensor data. In addition, these inference(s) may be based on position information, and device activity data. The publication module publishes the one or more presence indicators to a messaging server. These presence indicator(s) may indicate an activity and/or a location context of the user.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

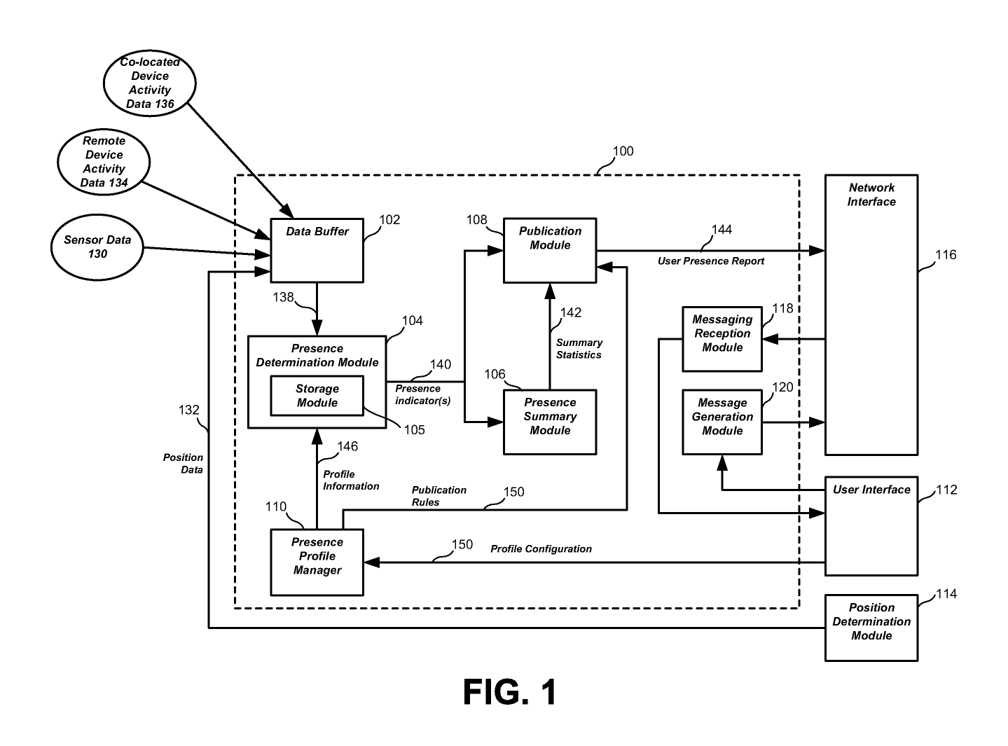

FIG. 1 illustrates one embodiment of an apparatus 100 that may provide presence information for messaging applications. Apparatus 100 may be included in various devices. Exemplary devices include computing devices, such as desktop, laptop, and notebook computers. Further exemplary devices include ultra mobile personal computers (UMPCs). Moreover, apparatus 100 may be included in personal digital assistants (PDAs), mobile phones, smartphones, mobile internet devices, and so forth. The embodiments, however, are not limited to these examples.

As shown in FIG. 1, apparatus 100 may include various elements. For instance, FIG. 1 shows that apparatus 100 may include a data buffer 102, a presence determination module 104, a presence summary module 106, a publication module 108, a presence profile manager 110, a messaging reception module 118, and a message generation module 120. These elements may be implemented in hardware, software, firmware, or in any combination thereof.

As described above, apparatus 100 may be included in a device that provides for the exchange of information with other devices. Moreover, apparatus 100 may be included within a messaging client of such a device. For purposes of illustration, FIG. 1 further shows apparatus 100 in the context of a user interface 112, a position determination module 114, and a network interface 116.

Apparatus 100 may participate in various distributed messaging applications. For instance, apparatus 100 may provide operations and features for a messaging client.

Data buffer 102 may include a storage medium, such as memory, that stores various forms of information pertaining to a user's activities, location, and so forth. For instance, data buffer 102 may receive sensor data 130, position data 132, remote device activity data 134, and/or co-located device activity data 136.

Such information may be received by data buffer 102 in various ways. For instance, FIG. 1 shows position data 132 being received from position determination module 114, which is described in greater detail below. In contrast, sensor data 130 and remote device activity data 134 may be received from one or more external networks via network interface 116. Such networks may be wired or wireless. Examples of such networks are described below.

Alternatively, co-located device activity data 136 may be received through one or more internal interconnections or interfaces. Exemplary interfaces include bus interfaces (e.g., computer system bus or universal serial bus (USB) interfaces), point-to-point connections (e.g., parallel interfaces, serial interfaces, etc.), and software interfaces.

Information received by data buffer 102 may be stored in various ways. For example, data buffer 102 may store the information in a sequential queue. Also, data buffer 102 may store the information in separate (e.g., parallel) queues for each data type. For example, data buffer 102 may provide a separate queue for each of sensor data 130, remote device activity data 132, position data 134, and co-located device activity data 136.

As shown in FIG. 1, presence determination module 104 receives buffered data 138 from data buffer 102. Such receipt may occur, for example, upon the issuance of a retrieval directive by presence determination module 104. However, buffered data 138 may be provided in other ways. For example, buffered data 138 may be provided at predetermined time intervals. Alternatively, buffered data 138 may be provided to presence determination module 104 when data buffer 102 stores a predetermined amount of data. The embodiments, however, are not limited to these examples.

Upon receipt of buffered data 138, presence determination module 104 may generate one or more presence indicators 140. Presence indicators 140 convey presence information that may provide a relatively deeper understanding of a user's status. The generation of these indicators may be in accordance with profile information 146 that is received from presence profile manager 110.

FIG. 1 shows that presence determination module 105 may include a storage module 105. Storage module 105 may contain presence attributes that may be included in presence indicators 140. Such attributes may indicate user activities and/or locations. Exemplary presence attributes include map data that identifies places or contexts (e.g., conference room, home, gym, etc.) from particular positional coordinates. Also, presence attributes may indicate Presence determination module 105 may select such attributes based on information received from data buffer 102. Accordingly, storage module 105 may be arranged as a look-up table or other data structure that provides attributes based on particular values of data 138. The embodiments, however, are not limited to this context. Storage module 105 may be implemented with a storage medium, such as memory.

FIG. 1 shows that presence indicator(s) 140 may be sent to publication module 108 and to presence summary module 106. Presence summary module 106 collects presence indicator(s) 140. Based on this collected information, presence summary module 106 calculates summary data 142. More particularly, presence summary module 106 aggregates presence indicators 140 over an interval of time to provide a more comprehensive or holistic view of the user's presence.

For example, presence summary module 106 may aggregate presence indicators 140 for the last n hours. In this example, n may be a user settable value. For instance, n may be in the range of 4-6 hours. However, the embodiments are not so limited.

As shown in FIG. 1, this aggregation of presence indicators may be processed to yield summary statistics 142. Exemplary summary statistics are provided below in Table 1.

TABLE 1

| Statistical Category | Associated Data |
|---|---|
| Time Window | Duration of time window for statistics collection |
| | in minutes |
| Holistic Indicator | Hectic, Busy, Average . . . |
| Talking | Total minutes and percentage of time window |
| | spent walking |
| Walking | Distance walked, and minutes & percentage of |
| | time window spent walking |
| Standing | Total minutes and percentage of time window |
| | spent standing |
| Sitting | Total minutes and percentage of time window |
| | spent sitting |
| Working on Computer | Total minutes and percentage of time window |
| | spent working on a computer |

Summary statistics 142 may advantageously provide information to others (e.g., colleagues, family members, etc.) who might benefit from a comprehensive view of the user's day. Additionally, such a comprehensive view may benefit to the user, as they can get a snapshot of their day. For example, a user may assess his utilization of time by reviewing statistics associated with various activities (e.g., number of hours on the phone, distance walked, time at desk/sitting down, etc).

As described above, presence profile manager 110 provides profile information 146 to presence determination module 104. This information may provide rules or parameters regarding the generation of presence indicators 140. For instance, profile information 146 may provide presence attributes to be stored in storage module 105. Also, profile information 146 may indicate certain presence identifiers that the user considers private and, thus, are not to be included in presence indicators 140.

Additionally, presence profile manager 110 may provide publication rules 150 to publication module 108. These rules may indicate, for example, one or more “buddies” that are allowed to view presence indicators 140 and/or summary statistics 142.

Profile characteristics (e.g., profile information 146 and publication rules 150) may be configured by the user. Accordingly, FIG. 1 shows presence profile manager 110 receiving a profile configuration 148 from user interface 112.

As shown in FIG. 1, publication module 108 generates a user presence report 144 from presence indicators 140, summary statistics 142, and publication rules 150. More particularly, FIG. 1 shows user presence report 144 being sent to network interface 116 for transmission to a messaging server (not shown). This transmission may be across one or more wired or wireless networks. User presence report 144 may include current presence data (which is conveyed in presence indicator(s) 140), summary statistics 142, and/or publication rules 150.

Referring again to data buffer 102, FIG. 1 shows that it may receive various types of data, such as sensor data 130, position data 132, remote device activity data 134, and co-located device activity data 136.

Sensor data 130 is received from one or more sensors through wireless or wired interfaces (not shown). These sensors may be within communicating proximity of the user. Accordingly, sensor data 130 may provide information regarding the environment and context of a user.

Exemplary sensors include pedometers, fitness sensors, heart rate monitors, body and environmental temperature sensors, accelerometers, microphones, and so forth. Thus, sensor data 130 may include information, such as the user's heart rate, the user's walking (or running) pace, and whether the user is standing, sitting, talking, or eating. Sensor data 130 may also include information about the user's environmental context, such as in a noisy café or in a quiet classroom.

Further exemplary sensors include sensors placed in various environments to indicate location. For instance, such sensors may include furniture sensors to indicate, for example, whether the user is sitting at his desk. Also, sensors may include speech monitors to indicate whether the user is talking.

Sensors, may be either wearable or non-wearable, as suitable for the type of sensor information being generated.

Position data 132 indicates the user's current location. As shown in FIG. 1, position data 132 may be provided by a position determination module 114. Position determination module 114 may include, for example, a global positioning system (GPS) receiver.

Alternatively or additionally, position determination module 114 may include a receiver that receives other types of signals. For example, position determination module 118 may include a receiver to receive network transmissions (e.g., cellular or IEEE 802.11 WiFi signals) from multiple devices, such as base stations or access points. From such transmissions, position determination module 114 may perform triangulation operations to determine a current location. For instance, embodiments (such as ones implemented with UMPCs) may provide indoor/outdoor location finding capabilities based on GPS & WiFi triangulation. Embodiments, however, may employ other position determination techniques.

Remote device activity data 134 provides information regarding user interaction with remote (e.g., proximate) devices. Examples of remote devices include computing platforms, telephones (e.g., either mobile, or wired), and so forth. For example, remote device activity data 134 may provide information regarding applications the user is operating (e.g., word processing, e-mail, etc.) on a computing device, and/or whether the user is engaging in a telephone conversation. Further, remote device activity data 134 may provide information regarding whether the user is operating a vehicle. The embodiments, however, are not limited to these examples. As described above, remote device activity data 134 may be received via network interface 116.

In contrast, co-located device activity data 136 provides information regarding user activities occurring on a same physical platform as apparatus 100. For example, in embodiments where apparatus 100 is included in a computing platform (e.g., a UMPC, PDA, smartphone, or a notebook computer), co-located activity data 136 may provide information regarding user applications (e.g., word processing, voice telephony, etc.) currently being employed by the user. However, this data may provide other types of information.

When inferring a presence indicator, multiple items of information may be used. Moreover, such information items may be sensor data 130, position data 132 remote device activity data 134, and/or co-located device activity data 136. For instance, as a non-limiting example, information regarding the operation of a car (e.g., remote device activity data 134) and information regarding location (e.g., position data 130) can indicate where (as well as to where) a user is driving. The embodiments, however, are not limited to such examples.

Network Interface 116 provides for the exchange of information with other devices across one or more networks. Such networks may be wireless and/or wired.

Exemplary wireless networks include wireless local area network (WLAN) links, such as IEEE 802.11 WiFi links, as well as wireless metropolitan area (WMAN) links such as IEEE 802.16 WiMax links and IEEE 802.16e WiBro links. Also, wireless networks may include personal area networks (PAN) links such as Bluetooth links. Further, wireless networks may include radio frequency identification (RFID) links. Moreover, such wireless networks may include cellular and satellite communications systems. The embodiments, however, are not limited to these examples.

Exemplary wired networks include, for example, local area networks (LANs), such as IEEE 802.3 Ethernet networks, and/or wired telephony networks. The embodiments, however, are not limited to these examples.

To provide such features, network interface 116 may include electronics, such as modulators, demodulators, amplifiers, filters, antennas and so forth. Moreover, network interface 116 may include components and/or functionality to operate according to one or more protocol layers. Such protocol layers may provide features, such as packet encapsulation/decapsulation, error correction coding, signaling, link protocols, and so forth. These features may be implemented in hardware, software, firmware, or any combination thereof.

Messaging reception module 118 receives (via network interface 116) information from a messaging server. For instance, messaging reception module 118 receives messages (e.g., instant messages) originated from other people and/or devices. In addition, messaging reception module 118 may receive presence information regarding others, as well as the user. As shown in FIG. 1, messaging module 118 forwards such information to user interface 112 for output (e.g., display) to the user.

Message generation module 120 provides for the preparation of messages (e.g., instant messages). This may involve receiving user input (e.g., text) from user interface 112 and placing the input into a format suitable for transmission (via network interface 116) to a messaging server.

User interface 112 facilitates user interaction. This interaction may involve the input of information from a user and/or the output of information to a user. Accordingly, user interface 112 may include one or more devices, such as a keyboard (e.g., a full QWERTY keyboard), a keypad, a touch screen, a microphone, and/or an audio speaker. The embodiments, however, are not limited to these examples.

Embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

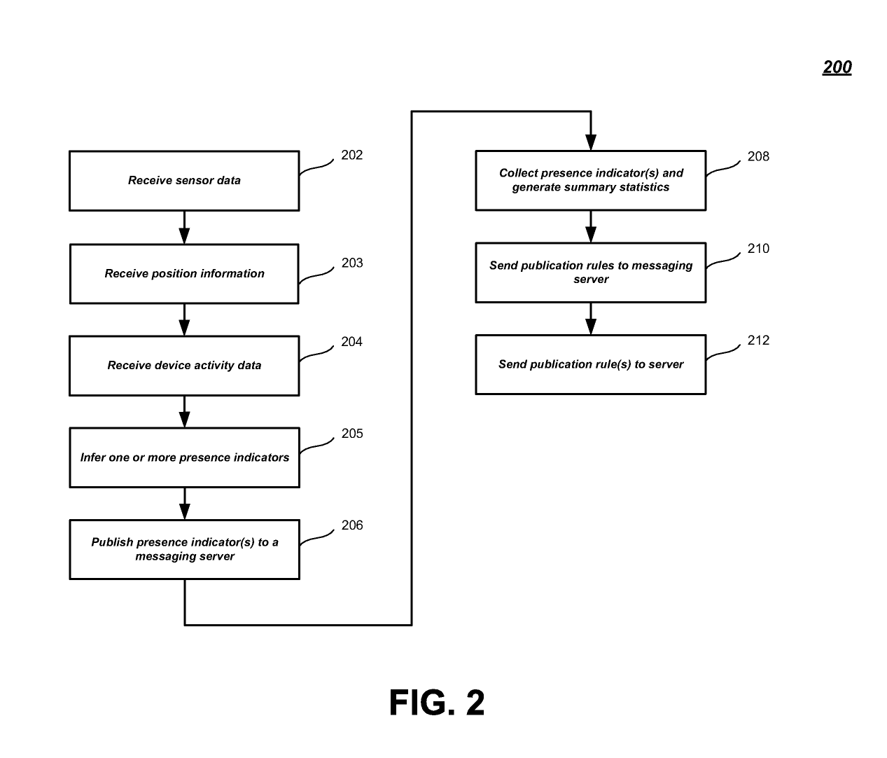

FIG. 2 illustrates one embodiment of a logic flow. In particular, FIG. 2 illustrates a logic flow 200, which may be representative of the operations executed by one or more embodiments described herein. Although FIG. 2 shows a particular sequence, other sequences may be employed. Also, the depicted operations may be performed in various parallel and/or sequential combinations.

As shown in logic flow 200, a block 202 receives sensor data from one or more sensors. Also, a block 203 receives position information identifying a location of the user. With reference to FIG. 1, this information may be received from position determination module 114. Further, a block 204 receives information regarding device activity. Referring again to FIG. 1, examples of such information include remote device activity data 134 and/or co-located device activity data 136.

A block 205 infers one or more presence indicators of the user. This inference may be based at least on the received sensor data, but may also be based on the received position information and or the received device activity data.

The presence indicators may indicate an activity and/or a location context of the user. In the context of FIG. 1, these presence indicators may be implemented as presence indicators 140.

As indicated by a block 206, the one or more presence indicators may be published to a messaging server. Further, a block 208 may collect such presence indicators over a time period and generate summary statistics regarding the collected indicators. Referring again to FIG. 1, this feature may be implemented by presence summary module 106.

As shown by a block 210 in FIG. 2, the summary statistics may then be published to a messaging server. This may involve transmitting information across one or more networks.

Also, FIG. 2 shows a block 212, which may send one or more publication rules to a messaging server. As described above, such rules may specify one or more “buddies” that are authorized to view the generated presence indicators and/or summary statistics.

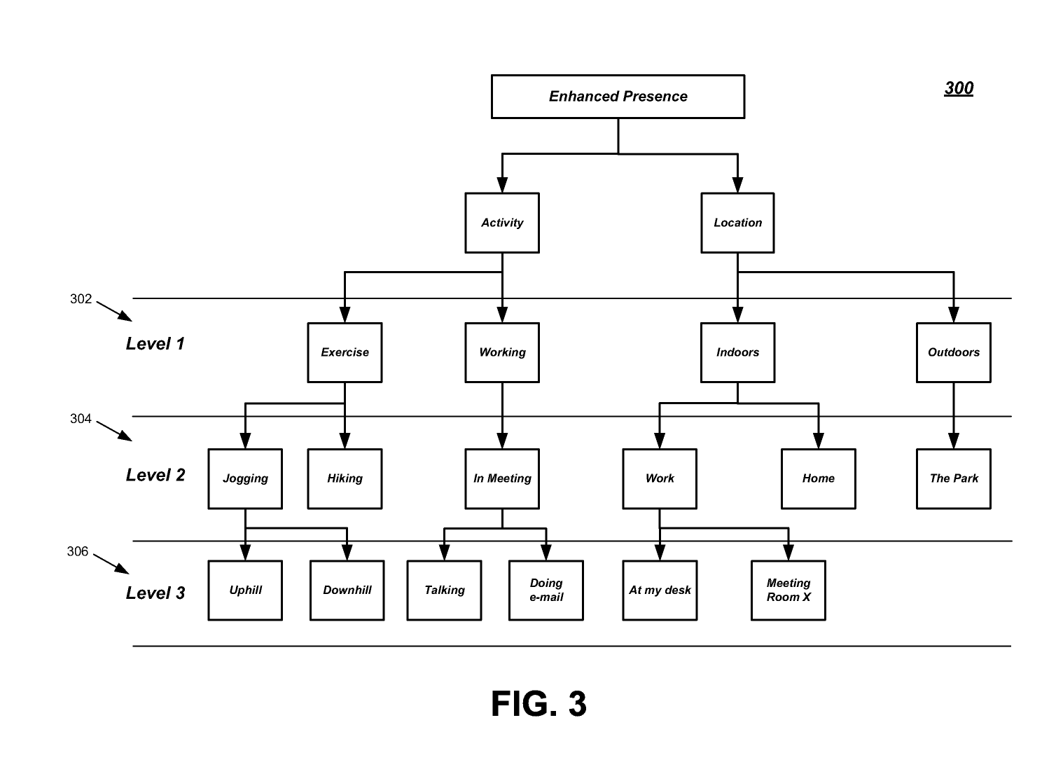

FIG. 3 is a diagram 300 illustrating a hierarchical arrangement of presence data. For instance, FIG. 3 shows multiple presence indicators that are distributed among multiple levels. Further, FIG. 3 shows a more generic classification of indicators into an activity category and a location category.

As shown in FIG. 3, presence indicators are distributed among a first level 302, a second level 304, and a third level 306. For instance, within first level 302 are “exercise”, “working”, “indoors”, and “outdoors” indicators. Levels 304 and 306 provide progressively more particular indicators. These more particular indicators may be based on (or inherited from) more general indicators at higher levels. For instance, second level 304 includes an “in meeting” indicator, which is based on the “working” indicator of first level 302. Also, second level 304, includes “jogging” and “hiking” indicators, which are based on the “exercise” indicator of first level 302. Further, third layer 306 includes “uphill” and “downhill” indicators, which are based on the “jogging” indicator of second layer 304. Additionally, third layer 306 includes “talking” and “doing e-mail” indicators, which are based on the “in meeting” indicator of second layer 304.

With reference to FIG. 1, each of these indicators may correspond to particular parameter settings (e.g., value(s), device activity messages, etc.) associated with information received by data buffer 102. Moreover, such particular parameter settings may established through presence profile manager 110 and maintained in storage module 105. However, the embodiments are not limited to this context.

Each of these levels may correspond to a degree of access. For instance, a user's peers may be authorized to obtain presence indicators within first level 302. However, presence indicators in levels 304 and 306 may be restricted to particular individuals or groups of individuals (e.g., family, close friends, work supervisors, etc.). Thus, users may control the type and granularity of enhanced presence information that is visible to their contacts. With reference to FIG. 1, a user may establish such restriction and or authorization features through the generation of publication rules 150.

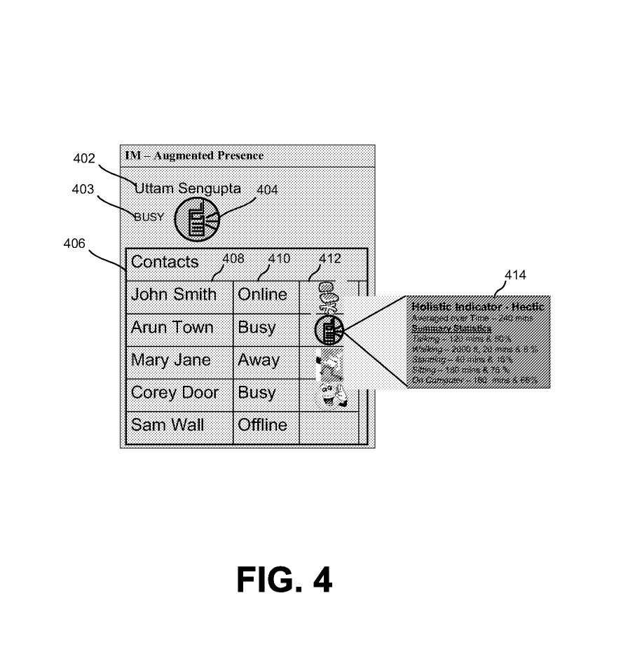

FIG. 4 is a view of an exemplary output that may be displayed by a user interface (e.g., user interface 112).

In particular, the output of FIG. 4 includes a user identifier 402 which provides a user's name (Uttam Sengupta). Further, the interface provides unenhanced presence indicator 403 (Busy) and an enhanced presence indicator 404 for the user. The enhanced presence indicator is an icon showing that the user is engaging in a telephone conversation.

Additionally, the interface of FIG. 4 includes a contact list 406 that provides information regarding various messaging contacts. The contact list is arranged in a table, in which each row corresponds to a particular contact. Within each row, a column 408 identifies the contact by name, a column 410 provides an unenhanced presence indicator for the contact.

However, a column 412 may provide (as an icon) an enhanced presence identifier for each contact. For instance, column 412 indicates that John Smith is sitting, Arun Town is engaging in a telephone conversation, Mary Jane is walking, and Corey Door is talking. The presentation of such an identifier is based on the contacts' publication rules. For instance, each contact may provide enhanced presence identifiers (if at all) based on publication rules that they establish for the user (Uttam Sengupta).

Additionally, summary statistics may be available for the contacts. For instance, FIG. 4 shows a summary report 414 for Arun Town. This report may be provided as a pop-up type graphic or window. As shown in FIG. 4, summary report 414 provides statistics regarding presence indicators collected over 240 minutes. Based on these statistics a holistic indicator of “Hectic” is determined.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a presence determination module to infer one or more presence indicators of a user based at least on sensor data received from one or more sensors; and
a publication module to publish the one or more presence indicators to a messaging server;
wherein the one or more presence indicators indicate an activity and/or a location context of the user.

2. The apparatus of claim 1, further comprising a position determination module to identify a current position of the user;
wherein the presence determination module is to infer the one or more presence indicators of the user based on at least data received from the one or more sensors and the current position.

3. The apparatus of claim 1, wherein the presence determination module is to select the one or more presence indicators from a plurality of predetermined activities and/or location contexts.

4. The apparatus of claim 3, further comprising a storage medium to store the plurality of predetermined activities and/or location contexts.

5. The apparatus of claim 4, wherein the plurality of predetermined activities and/or location contexts are provided by the user.

6. The apparatus of claim 4, wherein each of the plurality of predetermined activities is associated with one or more sensor data values.

7. The apparatus of claim 1, wherein the publication module is to publish the one or more indicators in accordance with one or more publishing rules.

8. The apparatus of claim 1, further comprising a presence summary module to generate one or more presence statistics regarding a time interval;
wherein the publication module is to publish the one or more presence statistics.

9. The apparatus of claim 1, further comprising an interface to receive sensor data from one or more sensors.

10. The apparatus of claim 1, wherein the one or more sensors include at least one wearable sensor.

11. The apparatus of claim 1, wherein the one or more sensors include at least one non-wearable sensor.

12. A method, comprising:
receiving sensor data from one or more sensors;
inferring one or more presence indicators of a user based at least on the received sensor data; and
publishing the one or more presence indicators to a messaging server;
wherein the one or more presence indicators indicate an activity and/or a location context of the user.

13. The method of claim 12, further comprising:
storing a plurality of predetermined activities and/or location identifiers; and
selecting the one or more presence indicators from the plurality of predetermined activities and/or location identifiers.

14. The method of claim 12, further comprising publishing the one or more presence indicators in accordance with one or more publishing rules.

15. An article comprising a computer-readable storage medium containing instructions that if executed enable a system to:
receive sensor data from one or more sensors;
infer one or more presence indicators of a user based at least on the received sensor data; and
publish the one or more presence indicators to a messaging server;
wherein the one or more presence indicators indicate an activity and/or a location context of the user.
